(19) United States
(12) Patent Application Publication
(10) Pub. No.: US 2023/0309504 A1
(43) Pub. Date: Oct. 5, 2023

(54) HOME AND TRAVEL COLLAPSIBLE DOG CRATE

(71) Applicant: John Michael Murray, Columbia, MO (US)

(72) Inventor: John Michael Murray, Columbia, MO (US)

(21) Appl. No.: 18/192,961

(22) Filed: Mar. 30, 2023

Related U.S. Application Data
(60) Provisional application No. 63/325,630, filed on Mar. 31, 2022.

(51) Int. Cl. A01K 1/02; A01K 1/00

(52) U.S. Cl. CPC A01K 1/0245; A01K 1/0035

(57) ABSTRACT

In an embodiment, a collapsible and portable pet crate has a rear, top, bottom, folding side, and front panels. The assembled crate may be collapsed by lifting the top panel and pressing the forward panel towards the rear panel as the side panels fold, folding the top panel over the front panel, and then folding the bottom panel over the front panel. Sliding hinges may be provided at the junction between the bottom plate and the rear plate to enable a smaller profile for the collapsed crate. Latches may be provided to secure the crate in the assembled and collapsed configurations. The rear wall may include wall mounting attachment(s), for example, magnetic assemblies that can be mated with another magnetic mounting on the user's wall for easy storage and/or enable collapsing the crate in much the same way as a Murphy bed.

### CROSS-REFERENCE TO RELATED APPLICATIONS

This application claims priority to U.S. Provisional Application No. 63/325,630, filed Mar. 31, 2022, and entitled, “Murphy Dog Crate 2.0”, the entirety of which is incorporated by reference.

### TECHNICAL FIELD

The technical field of the disclosed embodiments relate to collapsible and portable pet crates. More particularly, the disclosed embodiments relate to a collapsible pet crate than can be folded into a collapsed configuration that can be easily transported and/or secured when not in use.

### BACKGROUND

Owners of pets, especially dogs, may use crates to provide a secure place for their pets to calm down, sleep, and also to prevent them from damaging their home or belongings when unable to supervise them, either at home or when traveling.

A common type of dog crate is a solid housing typically made of heavy-duty materials such as metal frames, mesh wiring and/or thick plastic, which are designed to be durable and long-lasting. However, they can be challenging to transport due to their size, weight, and bulk, making them impractical for pet owners who need to move their dogs frequently, either within their homes or when traveling. These types of crates can also be difficult to store, taking up a lot of space when not in use.

### SUMMARY

Disclosed are various embodiments of a collapsible and portable pet crate. The pet crate may have a rear panel, top panel, bottom panel, two folding side panels, and a front panel including a door to allow a pet to enter and exit the assembled crate. In the assembled, or “crate”, configuration, the crate may have a generally box-like shape in which the top and bottom panels extend horizontally from hinges attached to the rear panel, with the side panels, rear panel, and front panel extending vertically supporting the top panel. Latches may be provided between the bottom panel and the side panels and front panel, as well as between the top panel and front panel to provide rigidity and structural integrity to the cage in this configuration.

The assembled crate may be collapsed by lifting the top panel and pressing the front panel towards the rear panel as the side panels fold. In an embodiment, the side panels may be suspended by their hinged attachment to the rear panel. In another embodiment, the folding side panels may include sliding elements on the front of the side panels slide along rails on the bottom panel. Once the front panel is fully retracted in a first collapsed position, the top panel may then be folded over the front panel in a second collapsed position. In this position, the bottom panel may be exposed to enable a user to clean the bottom panel and any bedding or other items therein. The bottom panel may then be folded over the top panel into a fully collapsed configuration. Sliding hinges may be provided at the junction between the bottom plate and the rear plate to enable a smaller profile for the collapsed crate.

The user may engage the side latches with mating elements on the rear panel to secure the collapsed cage into a package that is readily transported and/or stored. A handle may be provided to facilitate moving the collapsed crate.

The rear wall may include wall mounting attachment(s), for example, magnetic assemblies that can be mated with another magnetic mounting on the user's wall for easy storage and/or enable collapsing the crate in much the same way as a Murphy bed.

### BRIEF DESCRIPTION OF THE DRAWINGS

FIG. 1 is a perspective view of a collapsible pet crate according to an embodiment.

FIG. 2 is a perspective view of the collapsible pet crate of FIG. 1 showing front panel latch assemblies.

FIG. 3 is a perspective view of the collapsible pet crate of FIG. 1 showing a side panel latch assembly.

FIG. 4 is a perspective view of the collapsible pet crate of FIG. 1 showing a top panel latch assembly.

FIG. 5 is a perspective view of the top panel latch of FIG. 4 from a different view.

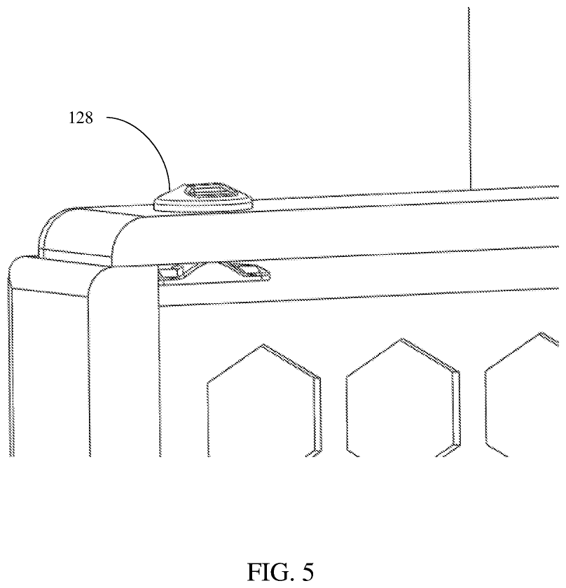

FIG. 6 is a perspective view of the collapsible pet crate of FIG. 1 during a first portion of a collapsing operation.

FIG. 7 is a perspective view of the collapsible pet crate of FIG. 1 during a second portion of the collapsing operation.

FIG. 8 is a perspective view of the collapsible pet crate of FIG. 1 during a third portion of the collapsing operation.

FIG. 9 is a perspective view of the collapsible pet crate of FIG. 1 in a fully collapsed configuration.

FIG. 10 is a perspective view of the collapsible pet crate of FIG. 1 showing a rear panel latch assembly connected to the bottom panel.

FIG. 11 is a perspective view of a sliding hinge assembly according to an embodiment.

FIG. 12 is a perspective view of a collapsible pet crate including a divider according to an embodiment.

FIG. 13 is a perspective view of a collapsible pet crate including a wall mounting assembly according to an embodiment.

FIG. 14 is a perspective view of the wall mounting assembly of FIG. 13.

FIG. 15 is an elevation view of the wall mounting assembly of FIG. 13.

### DETAILED DESCRIPTION

In an embodiment, a pet crate with a lightweight, durable design includes a folding mechanism enabling rapid set-up and breakdown for ease of transportation and storage. The pet crate may include a magnetic mounting mechanism to enable the collapsed (broken-down) crate to be secured to a wall to provide extra space when not in use.

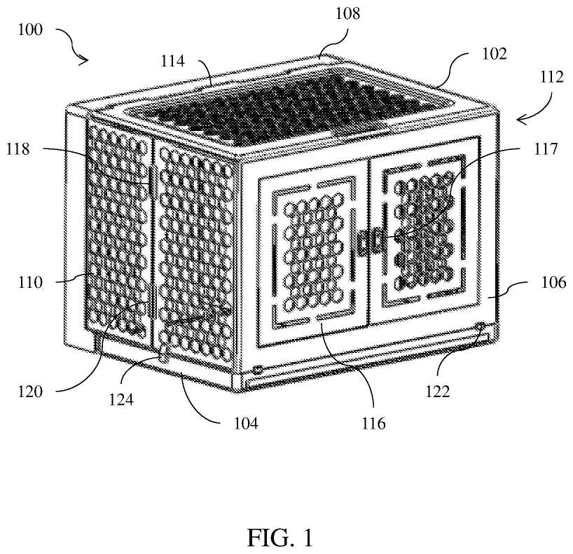

FIG. 1 shows a collapsible and portable pet crate 100 in an assembled or “crate” configuration according to an embodiment. The pet crate 100 may include a top panel 102, a bottom panel 104, a front panel 106, a rear panel 108, and left and right folding side panels 110, 112, respectively. The panels may include various apertures to enable the owner (user) to view their pet(s) and to provide sufficient air for their pet(s), while still providing sufficient strength to prevent the pet from escaping the crate. In an embodiment, the panels may be constructed from a molded plastic material, however other durable and lightweight materials may be used, for example, wire mesh panel sections attached to metal frames. Other materials and fabrication techniques are also contemplated, such as, for example, carbon fiber, wood, 3-D printing, computer numerical control (CNC), etc.

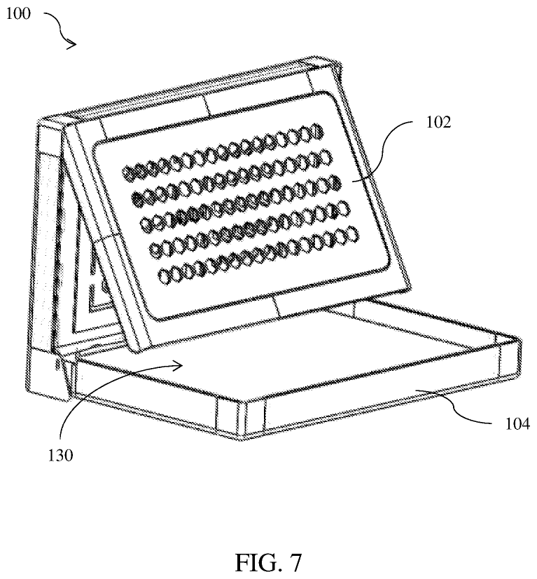

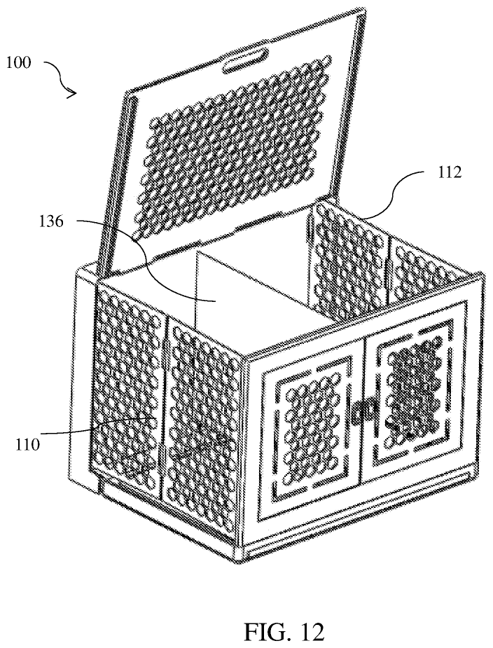

The top panel 102 may be attached to the rear panel 108 by bi-directional hinges 114 which enable the top panel 102 to be lifted to access the enclosed pet area (FIG. 12) or lowered during a folding operation described below (FIG. 7).

In an embodiment, the front panel 106 may include two doors 116 with door handles 117 to enable the pet to enter and exit the cage. Alternatively, a single, larger door may be used.

The folding side panels 110, 112 may include two sections connected by hinges 120 to enable to fold inwards when collapsing the pet crate 100.

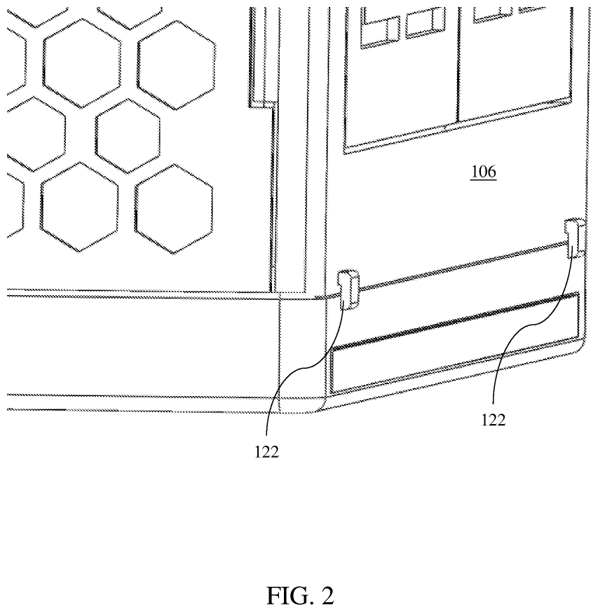

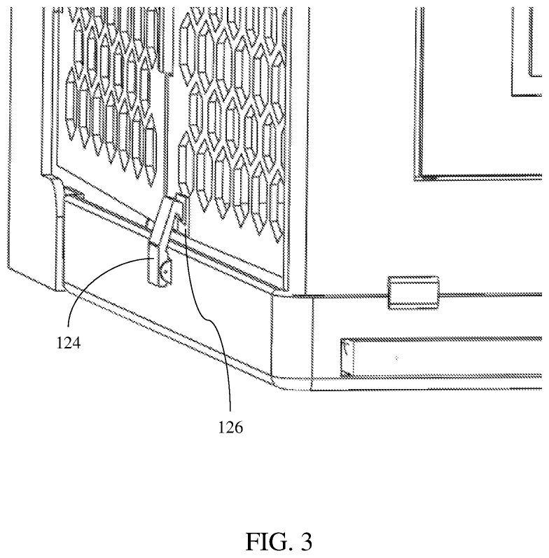

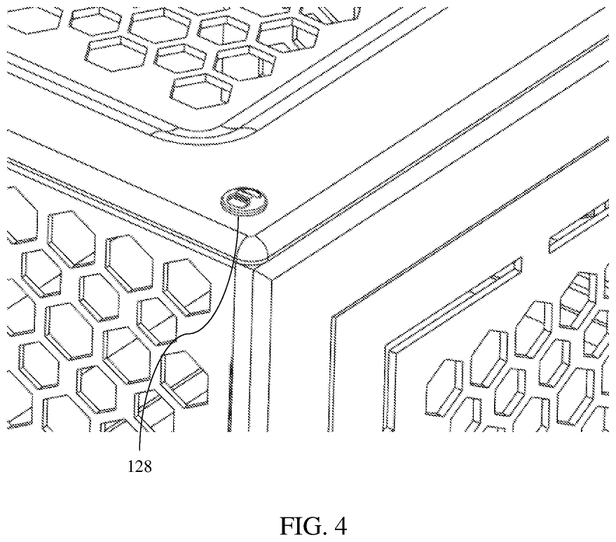

In the crate configuration, the structure may be secured may a number or latches or locks. The front panel 106 may be secured to the bottom panel 104 by front panel latch(es), or hooks, 122, as shown in FIG. 2. The side panels 110, 112 may be secured to the bottom panel 104 by bottom panel latches 124 which attach to female side panel latch elements 126 on the side panels, as shown in FIG. 3. The top panel 102 may be secured to the front panel 106 and/or the side panels 110, 112 by a twisting latch mechanism 128, as shown in FIGS. 4 & 5. Latching mechanisms 122, 124, 126, and 128 are merely exemplary. Other means to secure the panels together in the crate configuration are also contemplated.

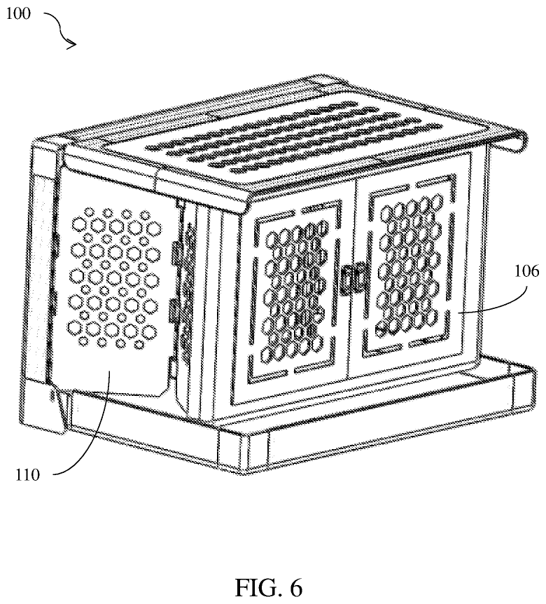

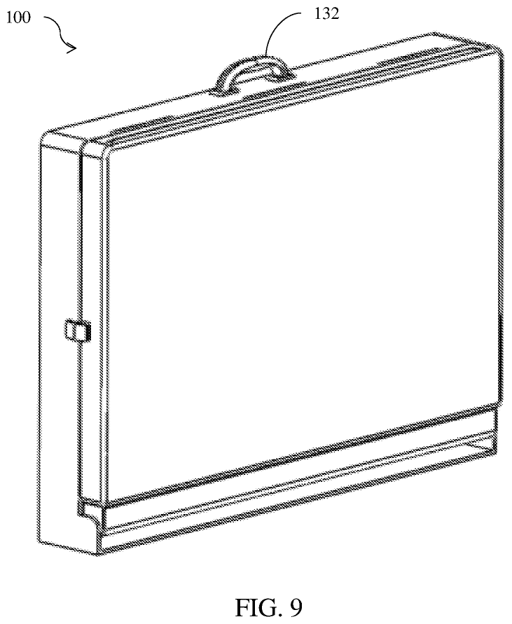

To fold the pet crate into a fully “collapsed” configuration (FIG. 9), the user may unlatch latches 122 and 124 and unlock top twisting locks 128. Once unsecured, front panel 106 may be pushed back to rear panel 108, as shown in FIGS. 6 &7. In an embodiment, the folding side panels 110, 112 may supported by their hinged attachment to the rear panel 108. In another embodiment, the bottom panel 104 may include grooves or rails on its left and right sides and mate with pins, wheels, bearings, or other sliding mechanisms provided near the front, bottom edges of the folding side panels 110, 112.

Once the front panel has been fully retracted into a first collapsed position, the top panel 102 may be folded down to cover the front panel 106, as shown in FIG. 7. Once the top panel 102 is fully folded down over the front panel 106 in a second collapsed position, the user has easy access to the bottom of the crate, which may include a recess 130 to house bedding, which may be removed and cleaned.

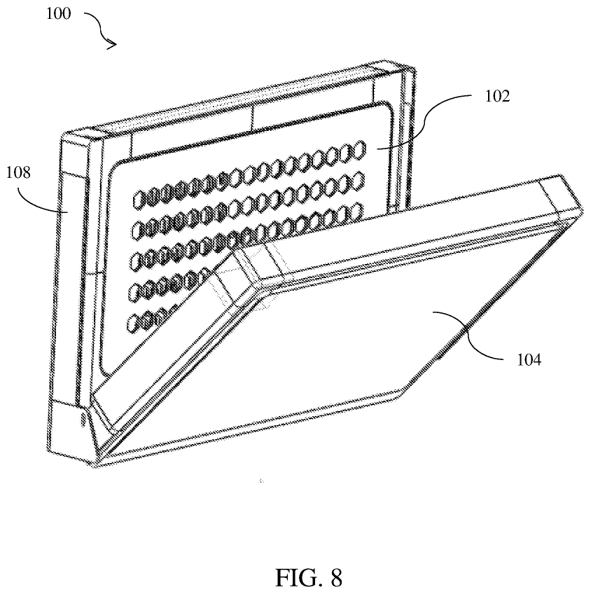

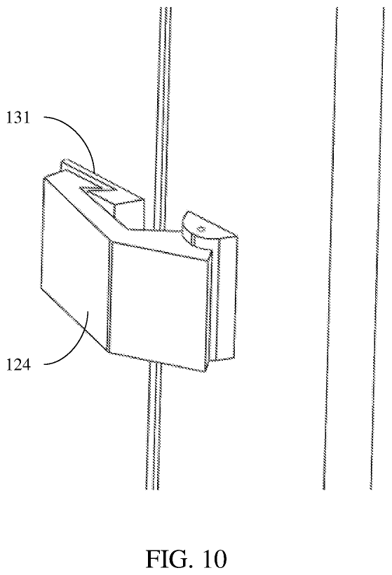

The bottom panel 104 may then be lifted up (FIG. 8) to completely close the assemble (FIG. 9). The bottom panel latches 124 may then be attached to rear panel latch elements 131 on the sides of the rear panel 108 to secure the assembly in a fully collapsed, or “closed”, configuration for transportation or storage, as shown in FIG. 10.

A handle 132 may be provided on the top of the rear panel 108 to enable the user to easily carry the collapsed pet crate.

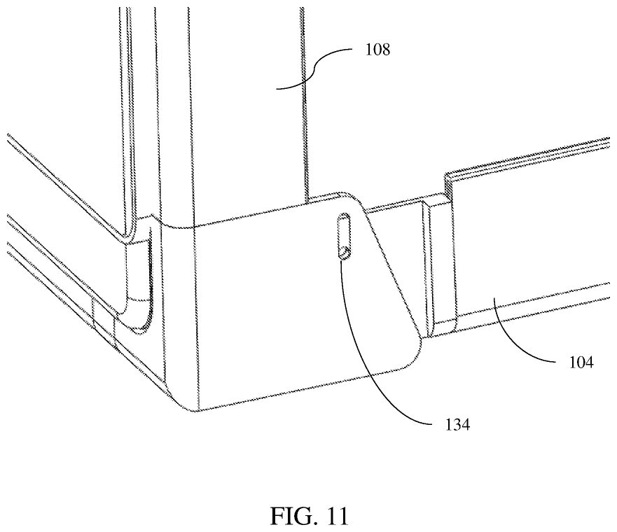

In an embodiment, the pet crate may be 37″ long by 26″ wide by 26″ tall (24.5″ tall without the handle) to accommodate dogs up to 22 inches tall and 30 inches long. In this embodiment, the collapsed pet crate may weigh only about fifteen pounds with a thickness of only 6.5″. To accommodate for this slim profile, a sliding hinge 134 may be provided at the junction between the bottom panel 104 and rear panel 108, providing flexibility at that joint when folding the two panels together, as shown in FIG. 11. In alternative embodiments, the dimensions of the pet crate 100 in the crate configuration and collapsed configuration may be modified to accommodate different sized pets.

In an embodiment, grooves may be provided in internal portions of the front panel 106 and rear panel 108 to enable the user to insert a “puppy” divider 136 between portions of the interior of the pet crate 100, as shown in FIG. 12. This may be useful for a puppy to have an appropriate and comfortable space while it is small and young, but provide a more appropriate space as it grows into adolescence and adulthood.

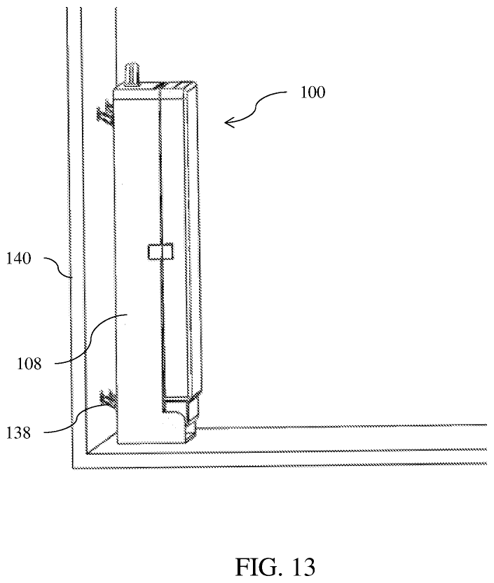

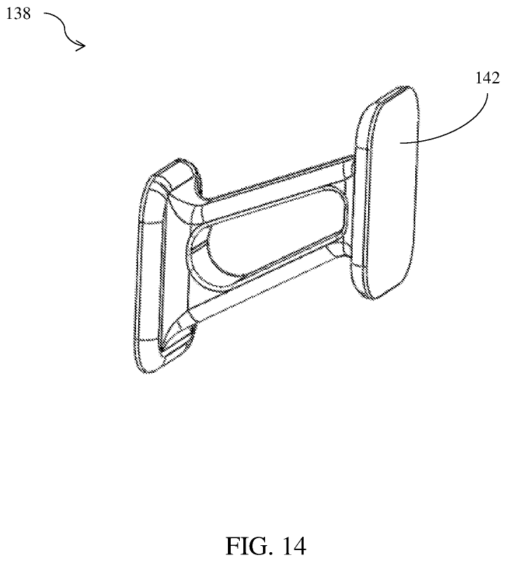

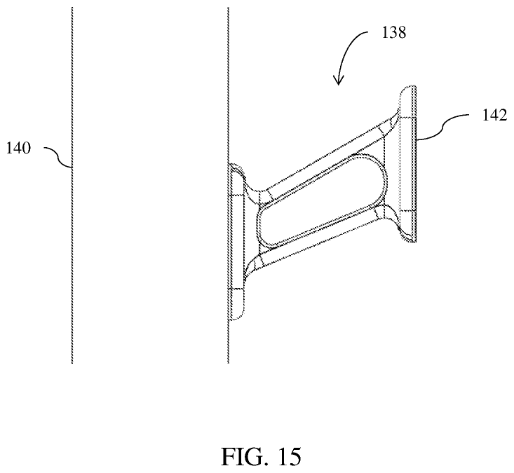

In an embodiment, a wall attachment assembly 138 may be affixed to a wall 140 for removable attachment to the wall 140, as shown in FIGS. 13-15. The wall attachment assembly 138 may include an attachment arm including a magnetic material 142 for mating with a corresponding magnet areas on the rear panel 108 with the opposite polarity of the magnetic material 142 on the wall attachment assembly 138. In this manner, the pet crate may be folded up and stored when not in use in much the same way as a Murphy bed in order to save floor space.

It is to be understood that the phraseology and terminology employed herein are for the purpose of description and should not be regarded as limiting. For example, the use of the articles “a,” “an,” or “the” is not to be construed as limiting the element to the singular. Further, the use of directional descriptors such as “up”, “upward”, “down”, “downward”, “front”, “back”, “rear”, “top”, “upper”, “bottom”, “lower”, “left”, “right” and other such terms refer to the device as it is oriented and appears in the drawings and are used for convenience only; they are not intended to be limiting or to imply that the device has to be used or positioned in any particular orientation.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. For example, other, non-magnetic types of releasable attachment devices may be used to attach the pet crate to a wall or another vertical structure in the user's dwelling. Thus, the present disclosure is not intended to be limited to the aspects illustrated herein but is to be accorded the widest scope consistent with the claims disclosed herein.

With respect to the above description, it is to be understood that described embodiments are not limited in its application to the details of construction and to the arrangement of the components in the following description or illustrations in the drawings. Other embodiments may be carried out in various ways and used with other items.

As such, those skilled in the art will appreciate that the conception upon which this disclosure is based may readily be utilized as a basis for the designing of other structures, methods, and systems for carrying out the several purposes of the present disclosed device.

1. A collapsible pet crate comprising:
a rear panel including a bottom portion and a top portion;
a bottom panel including
a front portion,
a first side,
a second side, and
a rear portion including a hinging mechanism connected to the bottom portion of the rear panel;
a top panel including a rear portion having a hinging mechanism connected to the top portion of the rear panel;
a front panel including
a first side,
a second side, and
a door;
a first folding side panel including
a front folding panel and a rear folding panel connected by a first hinging mechanism,
a second hinging mechanism connected between the rear folding panel and the first side of the rear panel, and
a third hinging mechanism connected between the front folding panel and the first side of the front panel; and
a second folding side panel including
a front folding panel and a rear folding panel connected by a first hinging mechanism,
a second hinging mechanism connected between the rear folding panel and the second side of the rear panel, and
a third hinging mechanism connected between the front folding panel and the second side of the front panel,
wherein the first folding side panel and second side panel are configured to fold along with the front panel into an engaged position with the rear panel in a first collapsed configuration, the top portion is configured to fold over the front panel exposing the bottom panel in a second collapsed configuration, and the bottom panel is configured to fold over the top panel in a fully collapsed configuration.

2. The collapsible pet crate of claim 1, wherein the bottom panel further comprises:
a front latching mechanism configured to secure the bottom panel to the front panel in a cage configuration in which the first and second side panels are extended such that the front panel is adjacent the front portion of the bottom panel;
a first side latching mechanism configured to secure the bottom panel the first folding side panel in the cage configuration and configured to secure the bottom panel to the rear panel in the fully collapsed configuration; and
a second side latching mechanism configured to secure the bottom panel the second folding side panel in the cage configuration and configured to secure the bottom panel to the rear panel in the fully collapsed configuration.

3. The collapsible pet crate of claim 2, wherein the top panel further comprises:
a latching mechanism configured to secure the top panel to at the front panel in the cage configuration.

4. The collapsible pet crate of claim 2, wherein the top panel further comprises:
a first latching mechanism configured to secure the top panel to the first folding side panel in the cage configuration; and
a second latching mechanism configured to secure the top panel to the first folding side panel in the cage configuration.

5. The collapsible pet crate of claim 1, wherein the rear panel further comprises an outer side including a magnetic wall mounting element.

6. The collapsible pet crate of claim 5, wherein the wall mounting element comprises a magnetic material.
